(19) United States
(12) Patent Application Publication
(10) Pub. No.: US 2022/0194137 A1
(43) Pub. Date: Jun. 23, 2022

(54) TIRE

(71) Applicant: Toyo Tire Corporation, Itami-shi (JP)

(72) Inventor: Naoya KUBO, Itami-shi (JP)

(73) Assignee: Toyo Tire Corporation, Itami-shi (JP)

(21) Appl. No.: 17/549,458

(22) Filed: Dec. 13, 2021

(30) Foreign Application Priority Data
Dec. 22, 2020 (JP) 2020-212713

(51) Int. Cl. B60C 11/03

(52) U.S. Cl. CPC B60C 11/0306; B60C 2011/0339

(57) ABSTRACT

A tire has land rows, and the number of the lands in each of the land rows is defined as the number of pitches. The number of pitches in an inner shoulder land row is the same as the number of pitches in a first land row. The number of pitches in an outer shoulder land row is the same as the number of pitches in a second land row. The number of pitches in the second land row is less than the number of pitches in the first land row.

This application is based on and claims the benefit of priority from Japanese Patent Application 2020-212713, filed on 22 Dec. 2020, the content of which is incorporated herein by reference.

### FIELD

The present invention relates to a tire.

### BACKGROUND

A known tire is configured to inhibit a noise from increasing due to pattern noises generated by the tire while the vehicle is traveling. For example, Japanese Patent No. 4266705 discloses a configuration in which rows of lands formed on a tread have different prime numbers of pitches. Due to this configuration, the numbers of pitches in the rows do not have any common divisor other than the respective numbers of pitches and 1, thereby preventing superimposition of noises of a frequency that can be caused by a common divisor of the numbers of pitches.

The tire disclosed in Patent Document 1 prevents pattern noises from being superimposed. However, tires are required to have not only the noise reduction performance but also high cornering power.

The present invention has been achieved in view of the above circumstances, and an object of the present invention is to provide a tire that can reduce pitch noises and can increase cornering power.

A tire of the present invention includes a tread constituting a tread surface as a ground-contacting surface adapted to come into contact with a road surface. The tread includes at least an inner shoulder land row that has a plurality of inner shoulder lands and is delimited by an inner main groove and a ground contact end, the inner main groove being an innermost groove in a width direction of a vehicle on which the tire is mountable, an outer shoulder land row that has a plurality of outer shoulder lands and is delimited by an outer main groove and a ground contact end, the outer main groove being an outermost groove in the width direction, a first land row that has a plurality of first lands and is delimited by a central main groove and the inner main groove, the central main groove being located between the inner main groove and the outer main groove in the width direction, and a second land row that has a plurality of second lands and is delimited by the central main groove and the outer main groove. The number of the lands in each of the land rows is defined as the number of pitches. The number of pitches in the inner shoulder land row is the same as the number of pitches in the first land row. The number of pitches in the outer shoulder land row is the same as the number of pitches in the second land row. The number of pitches in the second land row is less than the number of pitches in the first land row.

The present invention provides a tire that can reduce pitch noises and can increase cornering power.

### BRIEF DESCRIPTION OF THE DRAWINGS

FIG. 1 is a cross-sectional view of a tire according to a first embodiment, taken along a tire width direction;

FIG. 2 is a diagram illustrating the tire of FIG. 1, as viewed along the arrow II;

FIG. 3 is a diagram illustrating the position of a ground-contacting area of the tire of the first embodiment in a state where the vehicle is moving straight ahead;

FIG. 4 is a diagram illustrating the position of a ground-contacting area of the tire of the first embodiment in a state where the vehicle is cornering;

FIG. 5 is a diagram illustrating a tread of a tire according to a second embodiment, as viewed in the same direction as that along the arrow II in FIG. 1; and

FIG. 6 is a diagram illustrating a tread of a tire according to a modification of the first embodiment, as viewed in the same direction as that along the arrow II in FIG. 1.

### DETAILED DESCRIPTION OF THE EMBODIMENTS

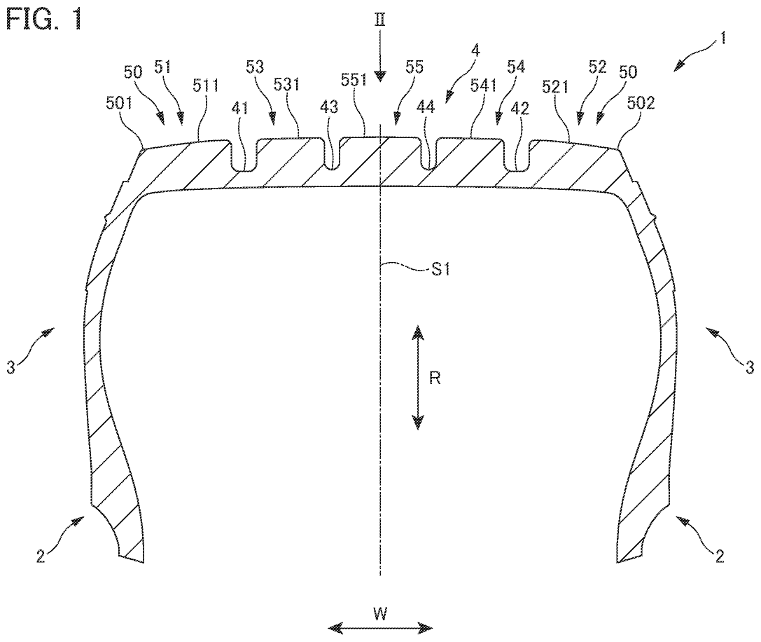

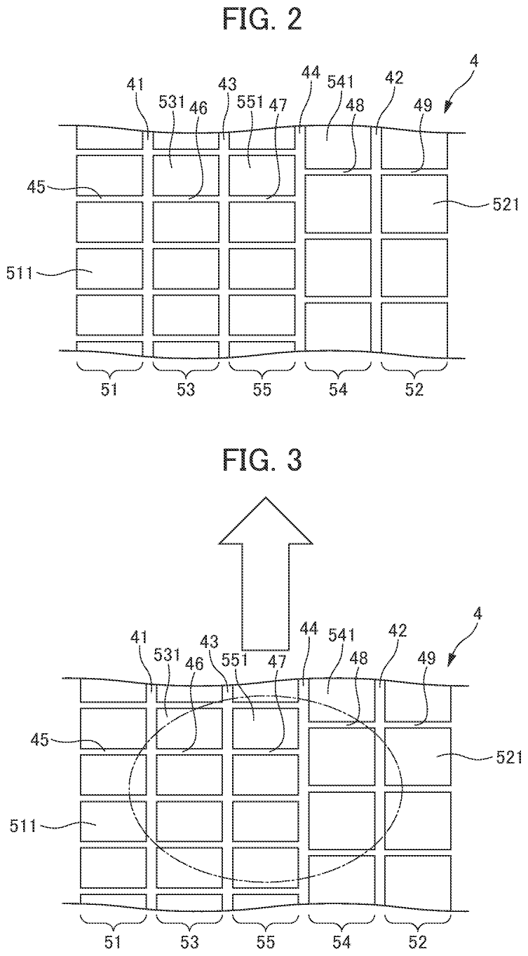

A first embodiment of the present disclosure will be described below with reference to the drawings. FIG. 1 is a cross-sectional view of a tire 1, taken along a tire width direction. FIG. 2 is a diagram illustrating the tire 1 of FIG. 1 as viewed along the arrow II. In the drawings, the reference character “S1” denotes a tire equatorial plane. The tire equatorial plane S1 is a plane that is orthogonal to a tire rotation axis (tire meridian) and is located at the center in the tire width direction.

Here, the tire width direction is a direction parallel to the tire rotation axis, and corresponds to the lateral direction on the page of the cross-sectional view as FIG. 1. In FIG. 1, the tire width direction is denoted by “W”. “Inside/inward in the tire width direction” refers to a direction toward the tire equatorial plane S1. “Outside/outward in the tire width direction” refers to a direction away from the tire equatorial plane S1. For the sake of convenience, inside and outside in a width direction of a vehicle on which the tire is mountable are defined as the left side and right side of FIG. 1, respectively.

A tire radial direction is a direction perpendicular to the tire rotation axis, and corresponds to the vertical direction on the page of FIG. 1. In FIG. 1, the tire radial direction is denoted by “R”. “Outside/outward in the tire radial direction” refers to a direction away from the tire rotation axis, and corresponds to the upward direction on the page of FIG. 1. “Inside/inward in the tire radial direction” refers to a direction toward the tire rotation axis, and corresponds to the downward direction on the page of FIG. 1.

The cross-sectional view illustrated in FIG. 1 is a cross section (including the tire meridian) of the tire 1 that is mounted on a predetermined rim and filled at a predetermined internal pressure in an unloaded state. The cross-sectional view is taken along the tire width direction. The predetermined rim refers to a standard rim determined by JATMA in accordance with the tire size. The predetermined internal pressure is, for example, 180 kPa when the tire 1 is a tire for passenger cars.

The tire 1 according to the present embodiment includes a pair of beads 2 that are provided on both sides in the tire width direction, sidewalls 3 that respectively extend outwardly in the tire radial direction from the beads 2, and an annular tread 4 that extends in the circumferential direction of the tire 1, constitutes a tread surface as a ground-contacting surface adapted to come into contact with a road surface, and is continuous with sides of the sidewalls 3, the sides being located outside in the tire radial direction. Shoulders 50 are formed outside the tread 4 in the tire width direction.

As shown in FIGS. 1 and 2, the tread 4 has a plurality of main grooves 41, 42, 43, 44, each of which continuously extends around the tire 1 in the tire circumferential direction. The main grooves 41, 42, 43, 44 each extend continuously in the tire circumferential direction.

Among the plurality of main grooves 41, 42, 43, 44, the main grooves 41, 42 that are the outermost two in the tire width direction constitute a pair of shoulder main grooves 41, 42. In more detail, the shoulder main groove 41 located inside with respect to the vehicle constitutes an inner shoulder main groove 41 as an inner main groove, while the shoulder main groove 42 located outside with respect to the vehicle constitutes an outer shoulder main groove 42 as an outer main groove. The main grooves 43, 44 located between the pair of shoulder main grooves 41, 42 constitute center main grooves 43, 44 as central main grooves.

The tread 4 includes: an inner shoulder land row 51 having a plurality of inner shoulder lands 511; an outer shoulder land row 52 having a plurality of outer shoulder lands 521 that are a plurality of lands; an inner intermediate land row 53 having inner intermediate lands 531 as first lands that are a plurality of lands; an outer intermediate land row 54 having outer intermediate lands 541 as second lands that are a plurality of lands; and a center land row 55 having a plurality of center lands 551 that are a plurality of lands. The inner intermediate lands 531 and the outer intermediate lands 541 will be described later.

The inner shoulder lands 511 are constituted by a plurality of lands delimited by the shoulder main groove 41 and a ground contact end 501. The outer shoulder lands 521 are constituted by a plurality of lands delimited by the shoulder main groove 42 and a ground contact end 502. The inner intermediate lands 531 are constituted by lands delimited by the main grooves 41, 43 adjacent to each other. The outer intermediate lands 541 are constituted by lands delimited by the main grooves 42, 44 adjacent to each other. The center lands 551 are constituted by a plurality of lands delimited by the main grooves 43, 44 adjacent to each other.

The center lands 551 constitute third lands. The inner intermediate land row 53 constitutes a first land row. The outer intermediate land row 54 constitutes a second land row. The center land row 55 constitutes a third land row. The center main grooves 43, 44 are arranged to sandwich the tire equatorial plane S1, whereby the center lands 551 are arranged to include the tire equatorial plane S1.

In a direction from inside to outside with respect to the width direction of a vehicle on which the tire 1 is mountable, the tire 1 has the inner shoulder lands 511 forming the inner shoulder land row 51, the inner intermediate lands 531 forming the inner intermediate land row 53, the outer intermediate lands 541 forming the outer intermediate land row 54, and the outer shoulder lands 521 forming the outer shoulder land row 52.

The number of the lands in each land row is herein defined as the number of pitches. More specifically, in the land rows, transverse grooves 45, 46, 47, 48, 49 extending in a direction intersecting with the main grooves 41 to 44 delimit individual lands so that the pattern of the individual land is repeated. The number of pitches means the number of times the pattern of the individual land is repeated in each land row.

In the present embodiment, the number of pitches in the inner shoulder land row 51 is the same as the number of pitches in the inner intermediate land row 53. The number of pitches in the outer shoulder land row 52 is the same as the number of pitches in the outer intermediate land row 54. The number of pitches in the outer intermediate land row 54 is less than the number of pitches in the inner intermediate land row 53. In the present embodiment, the number of pitches in the center land row 55 is the same as the number of pitches in the inner shoulder land row 51 and the number of pitches in the inner intermediate land row 53.

The number of pitches in the outer shoulder land row 52 and the number of pitches in the outer intermediate land row 54 are preferably 54 or more and 70 or less, and more preferably 58 or more and 66 or less. In the present embodiment, the number of pitches in the outer shoulder land row 52 is 62.

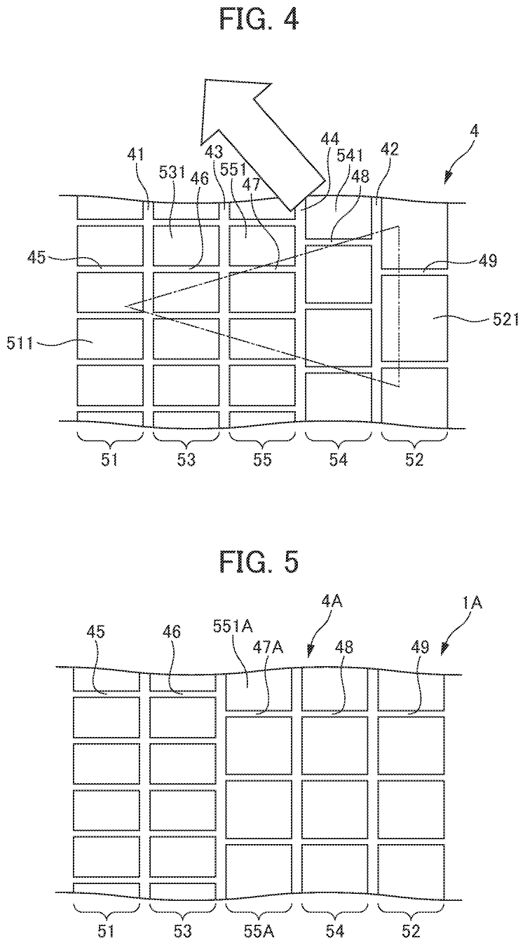

FIG. 3 is a diagram illustrating the position of a ground-contacting area of the tire 1 in a state where the vehicle is moving straight ahead. FIG. 4 is a diagram illustrating the position of a ground-contacting area of the tire 1 in a state where the vehicle is cornering. If the number of pitches is less than 54, the rigidity of each individual land (so-called pattern rigidity) becomes too high, making it difficult to increase a ground-contacting length, i.e., a length in the circumferential direction (the vertical length in FIGS. 3 and 4) of the ground-contacting area of the tire 1, which is surrounded by a dot-dash line in FIGS. 3 and 4. Referring to FIG. 3 illustrating the state where the vehicle is moving straight ahead in the direction indicated by the arrow, if the number of pitches is less than 54, there may be a risk in that the ground-contacting length of the oval-shaped ground-contacting area becomes extremely short only on an outer side with respect to the vehicle, and the ground-contacting area may become laterally asymmetric.

If the number of pitches exceeds 70, the pattern rigidity of each individual land becomes low, thereby softening each individual land. In particular, in the state where the vehicle is cornering in the direction indicated by the arrow in FIG. 4, the ground-contacting length is long in the outer intermediate land row 54 as illustrated in FIG. 4. Therefore, if the number of pitches in the outer intermediate land row 54 is increased, the pattern rigidity becomes too low, thereby making it impossible to achieve sufficient cornering power. Setting the number of pitches to 58 or more and 66 or less makes it possible to achieve a high pattern rigidity and a large ground-contacting length.

The number of pitches in the inner shoulder land row 51 and the number of pitches in the inner intermediate land row 53 are preferably 66 or more and 82 or less, and more preferably 70 or more and 78 or less. In the present embodiment, the number of pitches in the inner shoulder land row 51 is 74.

As in the case of the number of pitches in the outer intermediate land row 54, if the number of pitches is less than 66, the rigidity of each individual land (so-called pattern rigidity) becomes too high, making it difficult to increase a ground-contacting length, i.e., a length in the circumferential direction (the vertical length in FIGS. 3 and 4) of the ground-contacting area of the tire 1, which is surrounded by the dot-dash line in FIGS. 3 and 4. If the number of pitches exceeds 82, the pattern rigidity of each individual land becomes low, and each individual land becomes soft, whereby the vehicle is allowed to deviate from an intended direction. Setting the number of pitches to 70 or more and 78 or less makes it possible to achieve a high pattern rigidity and a large ground-contacting length.

The difference between the number of pitches in the inner intermediate land row 53 and the number of pitches in the outer intermediate land row 54 is preferably 8 or more. In the present embodiment, the difference between the numbers of pitches is 12.

Next, a second embodiment of the present disclosure will be described with reference to the drawings. FIG. 5 is a diagram illustrating a tread 4A of a tire 1A, as viewed in the same direction as that along the arrow II in FIG. 1. In the second embodiment, center lands 551A differ in configuration from the center lands of the first embodiment. Except for the center lands 551A, the configuration of the second embodiment is the same as that of the first embodiment. The same components are denoted by the same reference characters in the drawings, and a description of the same components will be omitted herein. Specifically, as illustrated in FIG. 5, the number of pitches in a center land row 55A is the same as the number of pitches in an outer shoulder land row 52 and the number of pitches in an outer intermediate land row 54. In the center land row 55A, the adjacent center lands 551A are delimited from each other in the tire circumferential direction of by a transverse groove 47A.

The tire 1 of the first embodiment and the tire 1A of the second embodiment were evaluated as Example 1 and Example 2, respectively. A tire as Comparative Example 1 was provided and evaluated, which had one main groove, an inner shoulder land row, and an outer shoulder land row. The number of pitches in each of the inner and outer shoulder rows was 68. A tire as Comparative Example 2 was provided and evaluated, which had two main grooves, an inner shoulder land row, a center land row, and an outer shoulder land row. The number of pitches in the inner shoulder land row was 74, the number of pitches in the center land row was 68, and the number of pitches in the outer shoulder land row was 62.

### <Evaluation of Cornering Power >

Using a drum-type tester with a diameter of 2500 mm, a cornering force generated on each test tire of 195/65R15 at an internal pressure of 200 kPa and under a load of 4.2 kN was measured, so that cornering power at a slip angle of 1 degree was determined. The result of Comparative Example 1 was defined as an index of 100, and an index-based evaluation was conducted. As the numerical value increases, the cornering power increases, indicating a good steering stability on a dry road surface.

### <Evaluation of Noise Reduction Performance >

Each test tire was mounted on a test vehicle, and a microphone was set on the driver's seat in the vehicle compartment at the position corresponding to an ear of a driver, so that a sound pressure was measured while the test vehicle was moving at 80 km/h on the surface of a flat asphalt road in dry conditions. The value of Comparative Example 1 was defined as 100, and the evaluation results were represented as an index, using the inverse numbers of the measurement values. As the index increases, the effect of reducing the pitch noises is enhanced and improved.

TABLE 1

| | Pitch | Cornering |
|---|---|---|
| | Noises | Power |
| Comparative Example 1 (Symmetric Pitches) | 100 | 100 |
| Comparative Example 2 (Asymmetric Pitches) | 104 | 102 |
| Example 1 (Asymmetric Pitches) | 103 | 104 |
| Example 2 (Asymmetric Pitches) | 103 | 105 |

As shown in Table 1, Comparative Example 2 having a configuration according to the conventional technique exhibited improved performance in relation to pitch noises, in comparison with Comparative Example 1, but the cornering power of Comparative Example 2 was not sufficiently increased. In contrast, Examples 1 and 2 exhibited sufficiently improved performance in relation to pitch noises although the performance was slightly inferior to that of Comparative Example 2. It is appreciated that the cornering power of Examples 1 and 2 was dramatically increased.

The tire 1 of the present embodiment exerts the following effects. According to the tire 1 of the present embodiment, the number of pitches in the inner shoulder land row 51 is the same as the number of pitches in the inner intermediate land row 53, the number of pitches in the outer shoulder land row 52 is the same as the number of pitches in the outer intermediate land row 54, and the number of pitches in the outer intermediate land row 54 is less than the number of pitches in the inner intermediate land row 53.

This feature can cause the pitch noises to have different frequencies and makes it possible to lower the peak of the noises, while ensuring a sufficient ground-contacting length and increasing the cornering power. As a result, the tire 1 is provided which can reduce the pitch noises and can exert increased cornering power.

The tire 1 according to the present embodiment has the plurality of center main grooves 43, 44 formed thereon. In addition, the tire 1 has the center land row 55, which has the plurality of center lands 551, and which is located between, and delimited by, the plurality of center main grooves 43, 44. Thus, the tire 1 can have a configuration in which four or more main grooves extend in the circumferential direction of the tire 1.

According to the tire 1 of the first embodiment, the number of pitches in the center land row 55 as the third land row is the same as the number of pitches in the inner intermediate land row 53 as the first land row. Thus, while the numbers of pitches are the same, since the ground-contacting area at which the tire 1 is in contact with the ground has the shape surrounded by the dot-dash line in FIGS. 3 and 4, treading surfaces as ground-contacting surfaces of the center lands 551, those of the inner intermediate lands 531, and those of the outer intermediate lands 541 come into contact with the road surface at different timings when the vehicle is traveling. This feature makes it possible to reduce the pitch noises.

Furthermore, the transverse grooves, which extend in the width direction of the tire 1 and which respectively delimit the center lands 551 from each other, the inner intermediate lands 531 from each other, and the inner shoulder lands 511 from each other in the circumferential direction of the tire 1, are arranged to have a positional relationship in which the transverse grooves coincide with each other in the width direction of the tire 1. This feature facilitates drainage and snow removal from the transverse grooves 47 in the center land row 55 through the transverse grooves 46, 45 in the inner intermediate land row 53 and the inner shoulder land row 51.

According to the tire 1A of the second embodiment, the number of pitches in the center land row 55A is the same as the number of pitches in the outer intermediate land row 54. Due to this feature, while the numbers of pitches are the same, treading surfaces as ground-contacting surfaces of the center lands 551A, those of the inner intermediate lands 531, and those of the outer intermediate lands 541 come into contact with a road surface at different timings when the vehicle is traveling, thereby making it possible to reduce the pitch noises.

Furthermore, the transverse grooves, which extend in the width direction of the tire 1 and which respectively delimit the center lands 551A from each other, the outer shoulder lands 521 from each other, and the outer intermediate lands 541 from each other, in the circumferential direction of the tire 1A, are arranged to have a positional relationship in which the transverse grooves coincide with each other in the width direction of the tire 1A. This feature facilitates drainage and snow removal from the transverse grooves 47A in the center land row 55A through the transverse grooves 48, 49 in the outer intermediate land row 54 and the outer shoulder land row 52.

According to the tire 1 of the present embodiment, the number of pitches in the outer shoulder land row 52 and the number of pitches in the outer intermediate land row 54 are 54 or more and 70 or less. This feature makes it possible to increase the rigidity (pattern rigidity) of the outer intermediate land row 54.

According to the tire 1 of the present embodiment, the number of pitches in the outer shoulder land row 52 and the number of pitches in the outer intermediate land row 54 are 58 or more and 66 or less. This feature makes it possible to reliably increase the rigidity (pattern rigidity) of the outer intermediate land row 54.

According to the tire 1 of the present embodiment, the number of pitches in the inner shoulder land row 51 and the number of pitches in the inner intermediate land row 53 are 66 or more and 82 or less. This feature can inhibit the vehicle from deviating from an intended direction.

According to the tire 1 of the present embodiment, the number of pitches in the inner shoulder land row 51 and the number of pitches in the inner intermediate land row 53 are 70 or more and 78 or less. This feature can reliably inhibit the vehicle from deviating from an intended direction.

According to the tire 1 of the present embodiment, the difference between the number of pitches in the inner shoulder land row 51 and the inner intermediate land row 53 and the number of pitches in the outer shoulder land row 52 and the outer intermediate land row 54 is 8 or more. This feature ensures that the pitch noises have different frequencies.

It should be noted that the above-described embodiments are not intended to limit the present invention, and that the scope of the present invention encompasses modifications and improvements that are made in the range where the object of the present invention can be achieved. For example, in the above-described embodiments, the inner intermediate lands 531, the outer intermediate lands 541, the center lands 551, and the center lands 551A, which are respectively adjacent to each other in the circumferential direction of the tire 1 (1A), are delimited by the associated wide transverse grooves 46, 48, 47, 47A extending in the direction intersecting with the main grooves 41 to 44. However, this configuration is a non-limiting example. For example, instead of the wide transverse grooves, sipes as narrow grooves may delimit the center lands from each other, the inner intermediate lands from each other, and the outer intermediate lands from each other in the tire circumferential direction. Specifically, the sipes have a width of about 0.6 mm to about 1.2 mm. This feature makes it possible to increase the pattern rigidity of the center lands, that of the outer intermediate lands, and that of the inner intermediate lands, thereby further increasing the cornering power.

For example, the inner shoulder lands 511 adjacent to each other and the outer shoulder lands 521 adjacent to each other in the circumferential direction of the tire 1 are respectively delimited from each other by the transverse grooves 45 and 49 extending in the direction intersecting with the main grooves 41 to 44. However, this configuration is a non-limiting example. For example, instead of the transverse grooves, slits as narrow grooves may delimit the outer shoulder lands from each other and the inner shoulder lands from each other. Specifically, the slits are wider than the sipes and have a width of 3.5 mm or less. In this case, in each land row, the pattern of the individual land that is delimited by slits or sipes extending in a direction intersecting with the main grooves is repeated. The number of pitches means the number of times the pattern is repeated in each land row.

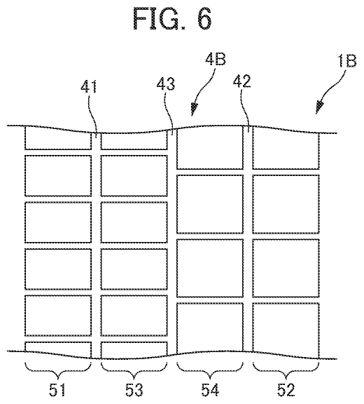

In the above-described embodiment, the tire 1 has the four main grooves, the inner shoulder lands 511, the inner intermediate lands 531, the center lands 551, the outer intermediate lands 541, and the outer shoulder lands 521. However, this configuration is a non-limiting example. For example, as illustrated in FIG. 6, the tire only needs to have at least three main grooves 41, 42, 43, and may have an inner shoulder land row 51, an inner center land row 53 as the first land row, an outer center land row 54 as the second land row, and an outer shoulder land row 52. FIG. 6 is a diagram illustrating a tread 4B of a tire 1B according to a modification of the first embodiment, as viewed in the same direction as that along the arrow II in FIG. 1

What is claimed is:

1. A tire comprising: a tread constituting a tread surface as a ground-contacting surface adapted to come into contact with a road surface,
wherein the tread comprises at least
an inner shoulder land row that has a plurality of inner shoulder lands and is delimited by an inner main groove and a ground contact end, the inner main groove being an innermost groove in a width direction of a vehicle on which the tire is mountable,
an outer shoulder land row that has a plurality of outer shoulder lands and is delimited by an outer main groove and a ground contact end, the outer main groove being an outermost groove in the width direction,
a first land row that has a plurality of first lands and is delimited by a central main groove and the inner main groove, the central main groove being located between the inner main groove and the outer main groove in the width direction, and
a second land row that has a plurality of second lands and is delimited by the central main groove and the outer main groove,
wherein the number of the lands in each of the land rows is defined as the number of pitches, and
wherein the number of pitches in the inner shoulder land row is the same as the number of pitches in the first land row, the number of pitches in the outer shoulder land row is the same as the number of pitches in the second land row, and the number of pitches in the second land row is less than the number of pitches in the first land row.

2. The tire according to claim 1,
wherein the central main groove comprises a plurality of central main grooves, and
wherein the tread further comprises a third land row that has a plurality of third lands and is located between, and delimited by, the plurality of central main grooves adjacent to each other in the width direction.

3. The tire according to claim 2,
wherein the number of pitches in the third land row is the same as the number of pitches in the first land row.

4. The tire according to claim 2,
wherein the number of pitches in the third land row is the same as the number of pitches in the second land row.

5. The tire according to claim 1,
wherein the number of pitches in the second land row is between 54 and 70 or.

6. The tire according to claim 2,
wherein the number of pitches in the second land row is between 54 and 70.

7. The tire according to claim 3,
wherein the number of pitches in the second land row is between 54 and 70.

8. The tire according to claim 4,
wherein the number of pitches in the second land row is between 54 and 70.

9. The tire according to claim 5,
wherein the number of pitches in the second land row is between 58 and 66.

10. The tire according to claim 6,
wherein the number of pitches in the second land row is between 58 and 66.

11. The tire according to claim 7,
wherein the number of pitches in the second land row is between 58 and 66.

12. The tire according to claim 8,
wherein the number of pitches in the second land row is between 58 and 66.

13. The tire according to claim 1,
wherein the number of pitches in the first land row is between 66 and 82.

14. The tire according to claim 13,
wherein the number of pitches in the first land row is 70 between and 78.

15. The tire according to claim 5,
wherein a difference between the number of pitches in the first land row and the number of pitches in the second land row 8 or more.
